(19) United States
(12) Patent Application Publication
(10) Pub. No.: US 2023/0018202 A1
(43) Pub. Date: Jan. 19, 2023

(54) POLYPHENYLENE SULFIDE OR POLYPHENYLENE SULFIDE ALLOY IMPACT-RESISTANT FUEL QUICK CONNECTOR

(71) Applicant: GM GLOBAL TECHNOLOGY OPERATIONS LLC, Detroit, MI (US)

(72) Inventor: Dennis M. D'HONDT, Ray, MI (US)

(73) Assignee: GM GLOBAL TECHNOLOGY OPERATIONS LLC, Detroit, MI (US)

(21) Appl. No.: 17/378,082

(22) Filed: Jul. 16, 2021

(51) Int. Cl. F16L 33/30; F16L 33/18; F16L 47/20

(52) U.S. Cl. CPC F16L 33/30; F16L 33/18; F16L 47/20; F16L 2201/40; C08L 81/02

(57) ABSTRACT

A fuel quick connector body according to various aspects of the present disclosure includes a wall. The wall extends along a longitudinal axis between a first end and a second end. The wall defines a passage between the first end and the second end. The body includes a polymer. The polymer includes polyphenylene sulfide in an amount greater than or equal to about 70 weight percent. The polymer may have a flexural modulus of less than or equal to about 4 GPa. The polymer may have a notched ISO impact strength of greater than or equal to about 25 kJ/m². The polymer may have an elongation at break of greater than or equal to about 15%. In various aspects, the present disclosure provides a fuel quick connector including the fuel quick connector body, a retainer component, and an O-ring.

### INTRODUCTION

This section provides background information related to the present disclosure which is not necessarily prior art.

Fuel connectors are used to connect fuel lines to the fuel pump, fuel filter, and other related fuel system components. A fuel quick connector may facilitate ease of assembly and removal to system components, such as tubing. However, components like fuel quick connectors necessarily come into contact with fuels, such as commercial petroleum-derived fuels or biodiesel fuels. These fuels may contain certain chemicals, such as ethanol, that could potentially lead to instability in certain materials forming the connectors. As such, fuel quick connectors with enhanced robustness in such environments would be advantageous.

### SUMMARY

This section provides a general summary of the disclosure, and is not a comprehensive disclosure of its full scope or all of its features.

The present disclosure relates to polyphenylene sulfide or polyphenylene sulfide alloy impact-resistant fuel quick-connector bodies, and quick connectors including the bodies, such as for gasoline fuel vapor or diesel fuel.

In various aspects, the present disclosure provides a fuel quick connector body. The fuel quick connector body includes a wall. The wall extends along a longitudinal axis between a first end and a second end. The wall defines a passage between the first end and the second end. The body includes a polymer including polyphenylene sulfide.

In certain aspects, the body is free of a filler.

In certain aspects, the polymer is a polymer alloy. The polymer alloy includes the polyphenylene sulfide in an amount greater than or equal to about 70 weight percent.

In certain aspects, the polymer alloy includes the polyphenylene sulfide in an amount greater than or equal to about 80 weight percent.

In certain aspects, the polymer alloy includes the polyphenylene sulfide in an amount greater than or equal to about 90 weight percent.

In certain aspects, the polymer consists essentially of the polyphenylene sulfide.

In certain aspects, the polymer has a flexural modulus of less than or equal to about 4 GPa.

In certain aspects, the polymer has a notched ISO impact strength of greater than or equal to about 25 kJ/m².

In certain aspects, the polymer has an elongation at break of greater than or equal to about 15%.

In certain aspects, the passage is configured to direct a liquid fuel.

In certain aspects, the liquid fuel is diesel fuel.

In certain aspects, the passage is configured to direct a vapor fuel.

In certain aspects, the vapor fuel includes gasoline or ethanol.

In certain aspects, the fuel quick connector body further includes a protrusion. The protrusion extends outwardly from the wall.

In various aspects, the present disclosure provides a fuel quick connector body. The fuel quick connector body includes a wall. The wall extends along a longitudinal axis between a first end and a second end. The wall defines a passage between the first end and the second end. The body includes a polymer. The polymer includes polyphenylene sulfide in an amount greater than or equal to about 70 weight percent. The polymer has a flexural modulus of less than or equal to about 4 GPa. The polymer has a notched ISO impact strength of greater than or equal to about 25 kJ/m². The polymer has an elongation at break of greater than or equal to about 15%.

In various aspects, the present disclosure provides a fuel quick connector. The fuel quick connector includes a body, a retainer component, and an O-ring. The body includes a polymer. The polymer includes polyphenylene sulfide. The body includes a wall and a protrusion. The wall extends along a longitudinal axis between a first end and a second end. The wall defines a passage between the first end and the second end. The protrusion extends from an outer surface of the wall. The protrusion is configured to engage a first tube portion. The retainer component is configured to couple a second tube portion to the wall. The O-ring engages the wall.

In certain aspects, the polymer is a polymer alloy. The polymer alloy includes polyphenylene sulfide in an amount greater than or equal to about 70 weight percent.

In certain aspects, the polymer consists essentially of the polyphenylene sulfide.

In certain aspects, the body is free of a filler.

In certain aspects, the polymer has a flexural modulus of less than or equal to about 4 GPa. The polymer has a notched ISO impact strength of greater than or equal to about 25 kJ/m². The polymer has an elongation at break of greater than or equal to about 15%.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a sectional view of a fuel quick connector according to various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the FIGURES. Spatially or temporally relative terms may be intended to encompass different orientations of the device or system in use or operation in addition to the orientation depicted in the FIGURES.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

As noted above, connectors may be used to connect fuel lines to the fuel pump, fuel filter, and other related fuel system components. Connectors may be used in connection with vapor fuel systems and liquid fuel systems. Vapor fuel systems may include gasoline fuel, ethanol-based fuel, and the like. Gasoline fuels may generally include hydrocarbons (e.g., alkanes, alkenes, isoalkanes, cycloalkanes, cycloalkenes, aromatic hydrocarbons), additives, and blending agents. Liquid fuels may include diesel fuels, biodiesel fuels, and the like.

Some connectors are formed from or include a filled polymer, such as nylon or polyphthalamide. Fillers may include glass and/or other fillers to increase strength, rigidity, chemical resistance, and/or dimensional stability. These filled connectors may have relatively high flexural modulus and relatively low elongation at break, which may lead to barrier failure and fracture, creating paths for possible fuel leakage. Other connectors, such as nylon connectors, may be unfilled. Unfilled nylon connectors may have a relatively lower flexural modulus and relatively higher elongation at break. However, unfilled nylon may be susceptible to volume swell, which may lead to dimensional changes and reduced retention of internal connector components. Unfilled nylon may have a lower fuel permeation resistance than filled nylon or filled polyphthalamide.

In various aspects, the present disclosures provides a fuel connector, such as a quick connector, for use with vapor fuel or liquid fuel. The fuel connector includes a body formed from or including a thermoplastic polymer including polyphenylene sulfide (PPS). The polymer may be PPS or a PPS alloy. In certain aspects, the body is unfilled, meaning free of any reinforcement fillers, like particles or fibers. The polymer may have a relatively low flexural modulus, a relatively high impact strength, and a relatively high elongation at break compared to other polymers used for connector bodies. The body may be configured to withstand sudden dynamic forces with reduced or no cracking and fracture. The body may be chemically-resistant to all commercial gasoline, ethanol, diesel, and biodiesel fuels. The body may be permeation-resistant to all commercial gasoline, ethanol, diesel, and biodiesel fuels.

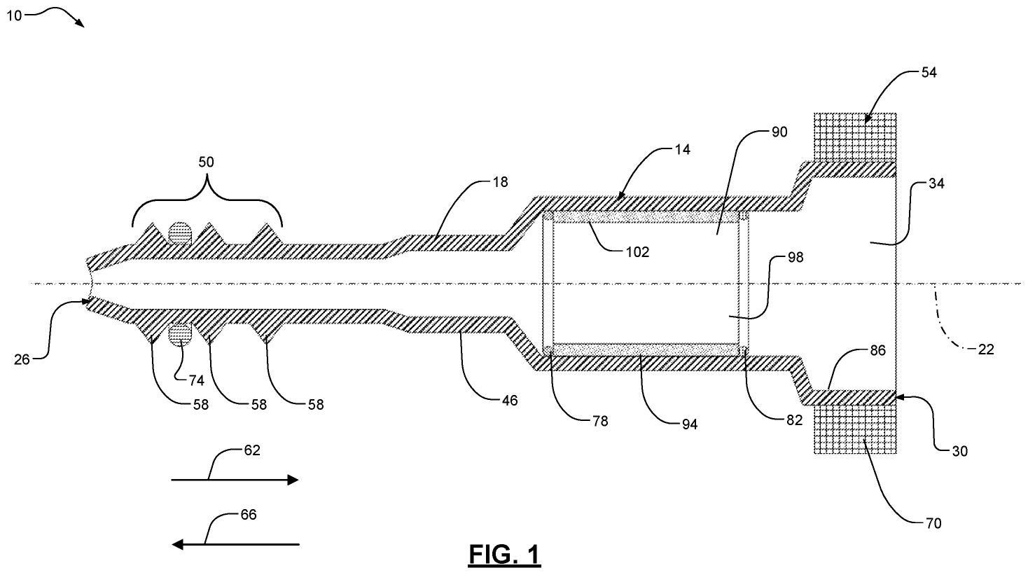

In various aspects, with reference to FIG. 1, the present disclosure provides a fuel connector, such as a fuel quick connector 10 (also referred to as the “connector 10”). The connector 10 includes a body 14. The connector 10 is not necessarily limited to the design shown and may include additional components coupled to the body 14, such as components configured to facilitate sealing and/or connection to tubing, as will be described in greater detail below.

The body 14 may be formed from or include a polymer. The polymer may be a thermoplastic polymer. The thermoplastic polymer may be electrically insulating, for example, having a minimum volume resistivity of greater than or equal to about 15×10¹⁵ ohm·cm. The thermoplastic polymer may include PPS. The PPS may be in the form of a PPS alloy or non-alloyed PPS. In certain aspects, the body 14 is substantially free of fillers (also referred to as “unfilled” polymer). In certain aspects, the body 14 consists essentially of the polymer.

In other aspects, the body 14 further includes a filler, such as a plurality of reinforcing particles or fibers. In certain aspects, the filler may include a carbon material (e.g., carbon black), glass, a mineral, or other suitable materials, by way of example. The filler may be included in an amount less than or equal to about 10 weight percent, optionally less than or equal to about 5 weight percent, optionally less than or equal to about 4 weight percent, optionally less than or equal to about 3 weight percent, optionally less than or equal to about 2 weight percent, optionally less than or equal to about 1 weight percent, or optionally less than or equal to about 0.5 weight percent, by way of example.

In certain aspects, the polymer includes non-alloyed PPS. In general, a polymer or plastic alloy is a homogeneous mixture or blend of two or more polymers. A non-alloyed polymer or plastic may thus contain only a single polymer. The polymer may include PPS in an amount greater than or equal to about 60 weight percent, optionally greater than or equal to about 65 weight percent, optionally greater than or equal to about 70 weight percent, optionally greater than or equal to about 75 weight percent, optionally greater than or equal to about 80 weight percent, optionally greater than or equal to about 85 weight percent, optionally greater than or equal to about 90 weight percent, optionally greater than or equal to about 95 weight percent, optionally greater than or equal to about 98 weight percent, or optionally greater than or equal to about 99 weight percent, by way of example. In certain aspects, the polymer consists essentially of PPS.

In certain aspects, the polymer includes a PPS alloy including the PPS. The PPS may be branched or a high molecular weight linear PPS. The PPS alloy is a polymer blend or mixture including PPS. That is, the PPS may be blended with another polymer to create the PPS alloy having different physical properties than its individual components. In certain aspects, PPS is blended with another thermoplastic polymer to create a PPS alloy having greater flexibility than non-alloyed PPS. In certain aspects, the PPS alloy may include RYTONXE3500BL™ PPS alloy by SOLVAY SPECIALTY POLYMERS, RYTONXE4500BL™ PPS alloy by SOLVAY SPECIALTY POLYMERS, RYTON XE5500BL™ PPS alloy by SOLVAY SPECIALTY POLYMERS, TECHTRON 1000™ PPS alloy by MITSUBISHI CHEMICAL ADVANCED MATERIALS, or any combination thereof, by way of example.

The PPS alloy may include the PPS in an amount greater than or equal to about 60 weight percent, optionally greater than or equal to about 65 weight percent, optionally greater than or equal to about 70 weight percent, optionally greater than or equal to about 75 weight percent, optionally greater than or equal to about 80 weight percent, optionally greater than or equal to about 85 weight percent, optionally greater than or equal to about 90 weight percent, optionally greater than or equal to about 95 weight percent, optionally greater than or equal to about 98 weight percent, or optionally greater than or equal to about 99 weight percent, by way of example.

In certain aspects, the polymer may have a relatively low flexural modulus compared to filled nylon or filled polyphthalamide. The flexural modulus of elasticity of the polymer (e.g., as determined according to ISO 178) may be less than or equal to about 5 GPa, optionally less than or equal to about 4.5 GPa, optionally less than or equal to about 4 GPa, optionally less than or equal to about 3.5 GPa, optionally less than or equal to about 3 GPa, optionally less than or equal to about 2.5 GPa, optionally less than or equal to about 2 GPa, optionally less than or equal to about 1.5 GPa, optionally less than or equal to about 1 GPa, optionally less than or equal to about 500 MPa, optionally less than or equal to about 250 MPa, optionally less than or equal to about 100 MPa, optionally less than or equal to about 50 MPa, optionally less than or equal to about 25 MPa, or optionally less than or equal to about 10 MPa, by way of example.

In certain aspects, the polymer may have a relatively high impact strength compared to filled nylon or filled polyphthalamide. The notched ISO impact strength (e.g., as determined according to ISO 180, Notch A) may be greater than or equal to about 1 kJ/m², optionally greater than or equal to about 2 kJ/m², optionally greater than or equal to about 5 kJ/m², optionally greater than or equal to about 10 kJ/m², optionally greater than or equal to about 15 kJ/m², optionally greater than or equal to about 20 kJ/m², optionally greater than or equal to about 25 kJ/m², or optionally greater than or equal to about 30 kJ/m², by way of example.

In certain aspects, the polymer may have a relatively high elongation at break compared to filled nylon or polyphthalamide. The elongation at break (e.g., as determined according to ASTM D638) may be greater than or equal to about 5%, optionally greater than or equal to about 7%, optionally greater than or equal to about 10%, optionally greater than or equal to about 12%, optionally greater than or equal to about 15%, optionally greater than or equal to about 18%, optionally greater than or equal to about 20%, or optionally greater than or equal to about 25%, by way of example.

With continued reference to FIG. 1, the body 14 may include a wall 18. The wall 18 may extend along a longitudinal axis 22 between a first end 26 of the connector 10 and a second end 30 of the connector 10. The wall 18 may have a generally tubular shape. The wall 18 may have a substantially cross section perpendicular to the longitudinal axis 22. In certain aspects, the wall 18 has rotational symmetry about the longitudinal axis 22.

The wall 18 defines a passage or bore 34. The passage 34 may extend between the first and second ends 26, 30 of the connector 10. The passage 34 may be configured to direct a vapor fuel or a liquid fuel. Flow through the passage may be in from the first end 26 to the second end 30, or from the second end 30 to the first end 26.

In certain aspects, the connector 10 is configured to be coupled to tubing that transports the fuel (not shown in FIG. 1). The connector 10 may be configured to be coupled to flexible tubing or rigid tubing. The tubing may be configured to be disposed around a portion of an outside surface 46 of the body 14 and/or be inserted at least partially into the passage 34.

The connector 10 may include connection features configured to facilitate coupling of the tubing to the body 14. Connection features may be integrally formed with the body 14 and/or discrete components coupled to the body 14. In certain aspects, the connector 10 includes a first connection feature 50 at or adjacent to the first end 26 and a second connection feature 54 at or adjacent to the second end 30.

In certain aspects, the first connection feature 50 includes a protrusion, or optionally a plurality of protrusions 58. The protrusions(s) 58 may be configured to engage an inside surface of flexible tubing that is disposed around a portion of the outside surface 46 of the body 14.

The protrusion(s) 58 may be annular protrusion(s), discrete protrusion(s), helical protrusion(s), or a combination thereof. The protrusion(s) 58 may define a rounded (e.g., semi-circular) cross-sectional shape, a triangular cross-sectional shape, a rectangular cross-sectional shape, or any combination thereof, by way of example. In certain aspects, protrusion(s) 58 may be arranged as barbs such that tubing may readily slide over a sloped surface of the protrusion(s) 58 in a first direction 62, but engage the tubing to prevent the tubing from sliding off the connector 10 in a second direction 66 opposite the first direction 62.

In certain aspects, the second connection feature 54 includes a retention device or retainer 70. The retention device 70 may be configured to secure an upset on a plastic or metal tube inserted into the passage 34. The retention device 70 may be formed from metal, molded plastic, or a combination of metal and plastic. In one example, the retention device 70 is configured to slide perpendicular to the longitudinal axis 22 to one or both sides of the tube upset to reduce or prevent movement of the tube upset parallel to the longitudinal axis 22. In another example, the retention device 70 includes molded plastic tabs that are configured to be displaced under compression during tube insertion and snap back behind the tube upset to retain the tube.

In certain aspects, the connector 10 further includes one or more O-rings configured to create a seal between the body 14 and tubing. The O-rings may be coupled to or engage the wall 18 of the body 14. The connector 10 may include a first O-ring 74. The first O-ring 74 may be disposed adjacent to the first end 26 and/or first connection feature 50. The first O-ring 74 may be disposed around an outside of the body 14 in communication with the outside surface 46. The first O-ring 74 may be configured to be compressed by an inside of the tube connected to the second end 26 of the body 14. The first O-ring 74 may be configured to remain static during use of the connector 10. The connector 10 may further include second and third O-rings 78, 82. The second and third O-rings 78, 82 may be disposed within the passage 34 in communication with an inside surface 86 of the body 14.

The O-rings 74, 78, 82 may be formed from a resilient material or a combination of resilient materials that have chemical resistance to a broad variety of fuels and fuel vapors, low fuel vapor permeation rate to reduce or minimize fuel emission, and/or good cold temperature flexibility. In certain aspects, the O-rings 74, 78, 82 may be formed from fluoroelastomer and/or fluorosilicone, each of which may be advantageous in select applications depending on the environment in which the connector 10 is used. Fluoroelastomer may have a lower fuel permeation and a higher chemical resistance than fluorosilicone. Fluorosilicone may have a better cold temperature flexibility than fluoroelastomer. In one example, one of the second and third O-rings 78, 82 is formed from fluoroelastomer and the other of the second and third O-rings 78, 82 is formed from fluorosilicone. In other aspects, the connector 10 may include different quantities of O-rings, such as one O-ring (e.g., the second or third O-ring 78, 82) or two O-rings (e.g., the first O-ring 74 and one of the second or third O-ring 78, 82).

In certain aspects, the connector 10 further includes a spacer 90. The spacer 90 may be disposed in the passage 34 between the second and third O-rings 78, 82. An outside surface 94 of the spacer 90 may be disposed against and in contact with the inside surface 86 of the body 14. The spacer 90 may include an interior region 98 configured to receive tubing such that an outside surface of the tubing engages an inside surface 102 of the spacer 90 and the second and third O-rings 78, 82. In certain aspects, the spacer 90 may be configured to retain and/or separate the second and third O-rings 78, 82, thereby minimizing the effect of any movement of the connected tube on the second and third O-rings 78, 82.

The connector 10 may be used to connect fuel lines on vehicles, such as automotive or other vehicles (e.g., motorcycles, boats, recreational vehicles), but may also be used in a variety of other industries and applications.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fuel quick connector body comprising:
a wall extending along a longitudinal axis between a first end and a second end, the wall defining a passage between the first end and the second end, the body comprising a polymer comprising polyphenylene sulfide.

2. The fuel quick connector body of claim 1, wherein the body is free of a filler.

3. The fuel quick connector body of claim 1, wherein the polymer is a polymer alloy comprising the polyphenylene sulfide in an amount greater than or equal to about 70 weight percent.

4. The fuel quick connector body of claim 3, wherein the polymer alloy comprises the polyphenylene sulfide in an amount greater than or equal to about 80 weight percent.

5. The fuel quick connector body of claim 4, wherein the polymer alloy comprises the polyphenylene sulfide in an amount greater than or equal to about 90 weight percent.

6. The fuel quick connector body of claim 1, wherein the polymer consists essentially of the polyphenylene sulfide.

7. The fuel quick connector body of claim 1, wherein the polymer has a flexural modulus of less than or equal to about 4 GPa.

8. The fuel quick connector body of claim 1, wherein the polymer has a notched ISO impact strength of greater than or equal to about 25 kJ/m².

9. The fuel quick connector body of claim 1, wherein the polymer has an elongation at break of greater than or equal to about 15%.

10. The fuel quick connector body of claim 1, wherein the passage is configured to direct a liquid fuel.

11. The fuel quick connector body of claim 10, wherein the liquid fuel is diesel fuel.

12. The fuel quick connector body of claim 1, wherein the passage is configured to direct a vapor fuel.

13. The fuel quick connector body of claim 12, wherein the vapor fuel includes gasoline or ethanol.

14. The fuel quick connector body of claim 1, further comprising a protrusion extending outwardly from the wall.

15. A fuel quick connector body comprising:
a wall extending along a longitudinal axis between a first end and a second end, the wall defining a passage between the first end and the second end, the body comprising a polymer comprising polyphenylene sulfide in an amount greater than or equal to about 70 weight percent, wherein:
the polymer has a flexural modulus of less than or equal to about 4 GPa,
the polymer has a notched ISO impact strength of greater than or equal to about 25 kJ/m², and
the polymer has an elongation at break of greater than or equal to about 15%.

16. A fuel quick connector comprising:
a body comprising a polymer comprising polyphenylene sulfide, the body comprising:
a wall extending along a longitudinal axis between a first end and a second end, the wall defining a passage between the first end and the second end, and
a protrusion extending from an outer surface of the wall, the protrusion configured to engage a first tube portion;
a retainer component configured to couple a second tube portion to the wall; and
an O-ring engaging the wall.

17. The fuel quick connector of claim 16, wherein the polymer is a polymer alloy comprising the polyphenylene sulfide in an amount greater than or equal to about 70 weight percent.

18. The fuel quick connector of claim 16, wherein the polymer consists essentially of the polyphenylene sulfide.

19. The fuel quick connector of claim 16, wherein the body is free of a filler.

20. The fuel quick connector of claim 16, wherein:
the polymer has a flexural modulus of less than or equal to about 4 GPa,
the polymer has a notched ISO impact strength of greater than or equal to about 25 kJ/m², and
the polymer has an elongation at break of greater than or equal to about 15%.
